(19) United States
(12) Patent Application Publication
(10) Pub. No.: US 2011/0249204 A1
(43) Pub. Date: Oct. 13, 2011

(54) ROOF AND SIDE MOUNTED MEDIA CENTER FOR VEHICLES

(76) Inventor: Carl H. Hamilton, Galloway, OH (US)

(21) Appl. No.: 13/046,067

(22) Filed: Mar. 11, 2011

Related U.S. Application Data
(60) Provisional application No. 61/313,900, filed on Mar. 15, 2010.

(51) Int. Cl. H04N 5/64

(52) U.S. Cl. 348/837; 348/E05.128

(57) ABSTRACT

Embodiments of the present invention relate generally to media centers and, more particularly, to media centers for mounting on vehicle roofs. Embodiments also relate generally to vehicles comprising roof mounted media centers. Embodiments also relate generally to vehicles comprising exterior mounted media centers, more particularly, to media centers for mounting on a vehicle side.

### CROSS REFERENCE TO RELATED APPLICATIONS

This application claims the benefit of U.S. Provisional Application Ser. No. 61/313,900, filed Mar. 15, 2010.

### BRIEF SUMMARY OF THE INVENTION

Embodiments of the present invention relate generally to media centers and, more particularly, to media centers for mounting on vehicle roofs. Embodiments also relate generally to vehicles comprising roof mounted media centers. Embodiments also relate generally to vehicles comprising exterior mounted media centers, more particularly, to media centers for mounting on a vehicle side.

A media center generally comprises one or more chambers and one or more video monitors. The video monitors may comprise any conventional or yet to be developed video monitors. Generally, however, the monitors comprise flat screen plasma display, liquid crystal display (LCD), and/or digital light processing (DLP) monitors. The monitors may comprise any desirable dimensions and are not limited to any particular size. The monitors generally comprise a power cable for connection to an electric power source for operation of the monitors.

The media center may comprise a single chamber that defines a shape of the media center or a plurality of chambers connected to define a shape of the media center. One or more video monitors may be enclosed in, but viewable from outside of, the chamber(s). It is contemplated that a chamber may enclose no monitors, a single monitor, or two or more monitors. The chambers are operable to enclose the video monitors therein so that the monitors are protected from environmental elements, such as dust, wind, moisture, and precipitation. The chambers may be configured of any variety of materials sufficient to perform the purposes described herein. The chambers generally respectively comprise a plurality of walls. The plurality of walls generally comprise a base wall, one or more side walls, and one or more viewing walls. The base wall serves as a bottom surface of the chamber and may be mounted to the roof of a vehicle. The side walls project up from the base wall end and connect to the viewing walls. One or more of the side walls may be readily removable from other walls of the chamber for maintenance, repair, and/or replacement of video monitors and/or cables. The viewing walls comprise one or more viewing windows through which the video monitors may be viewed from outside of the chambers. The plurality of walls are interconnected to form the chambers and to enclose the video monitors.

### BRIEF DESCRIPTION OF THE SEVERAL VIEWS OF THE DRAWINGS

FIGS. 1-12 illustrate the roof and side mounted media center for vehicles.

### DETAILED DESCRIPTION OF THE INVENTION

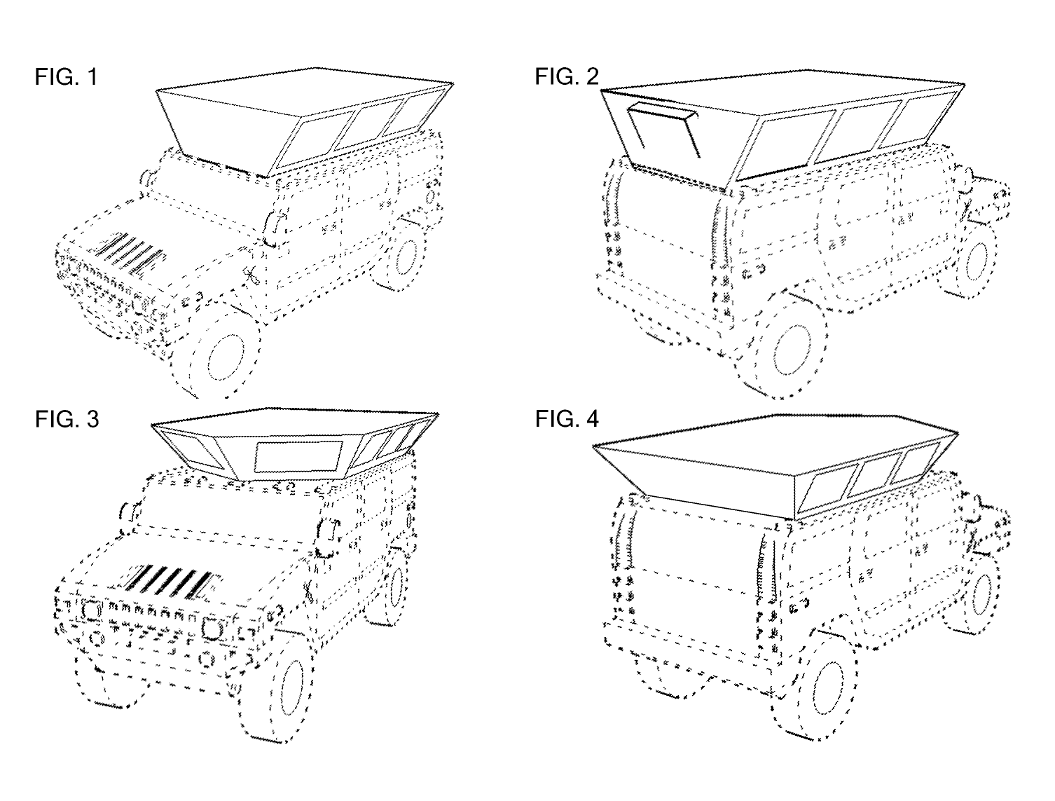

As shown in FIGS. 1-12, the walls forming the chambers are interconnected such that the viewing walls project angularly out from the base wall. Thereby, when mounted to a roof of a vehicle, the viewing walls, and thus, the monitors as well, are tilted out over a side of the vehicle. The tilt comprises an angle generally appropriate for optimal viewing of the video monitors by individuals standing and/or sitting along side the vehicle. Optimal viewing generally refers to a minimization of glare and a maximization of video clarity of video monitors of media centers mounted on vehicle roofs. Thereby, optimal viewing of the monitors is enabled for viewers from any number of positions relative to the video monitors and the vehicle. The media center may comprise an awning, or other shade providing device, that may be applied to one or more of the chambers to further optimize viewing of the video monitors. This awning may be secured to the roof or other walls of the media center and may extend over the viewing walls when desired and retract when not needed or prior to transportation of the media center. The awning may be extended and retracted manually or via a linear actuator or other device. In addition or in the alternative, the awning may be readily secured and removed from the chambers as desired.

Relative to the base wall, the angle of the tilt of the viewing wall and monitors is more than 90° and less than 180° and, more particularly, generally is between about 110° and about 130°. For example, in one embodiment, the tilt of the viewing walls and the monitors respectively comprise an angle of about 120° relative to the respective base walls. The present inventors also contemplate that all of the viewing walls and monitors need not necessarily comprise the same angle of tilt. For example, a viewing wall and monitor of a chamber viewable from before a vehicle, when mounted thereon, may comprise a tilt angle of about 110° relative to its base wall, while the viewing walls and monitors of chambers viewable from the sides and behind the vehicle may comprise a tilt angle of about 120° relative to their base walls.

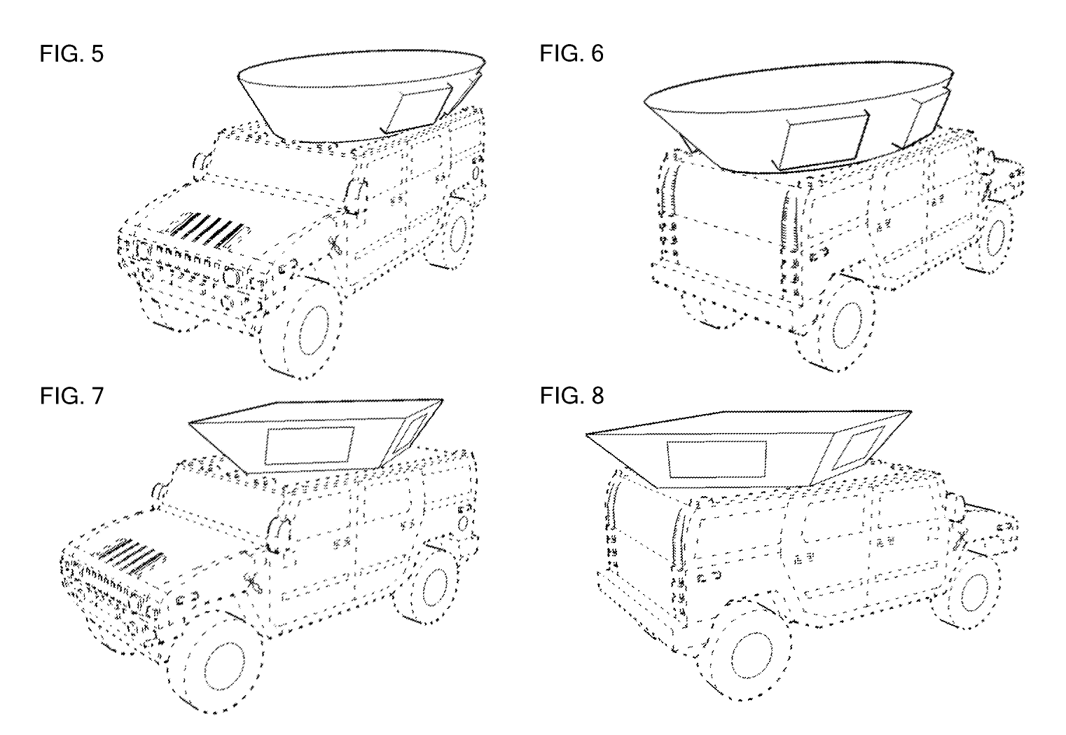

The plurality of walls may be shaped and/or interconnected to form a chamber comprising a variety of shapes and/or configurations in which the viewing walls and/or monitors maintain the tilt relative to the base wall. For example, one or more of the walls may comprise a polygonal shape and/or planar surface or a curved surface. Further, as shown in FIG. 2 where a viewing wall is perpendicular to the base wall of the chamber and in FIGS. 5, 6, 9, and 10 where a viewing wall comprises a curved surface, the viewing wall may be configured such that the viewing window projects outward from the viewing wall at an angle of tilt described above. Thereby, the video monitor viewable through the viewing window may tilt outward from the viewing wall to the angle defined by the viewing window.

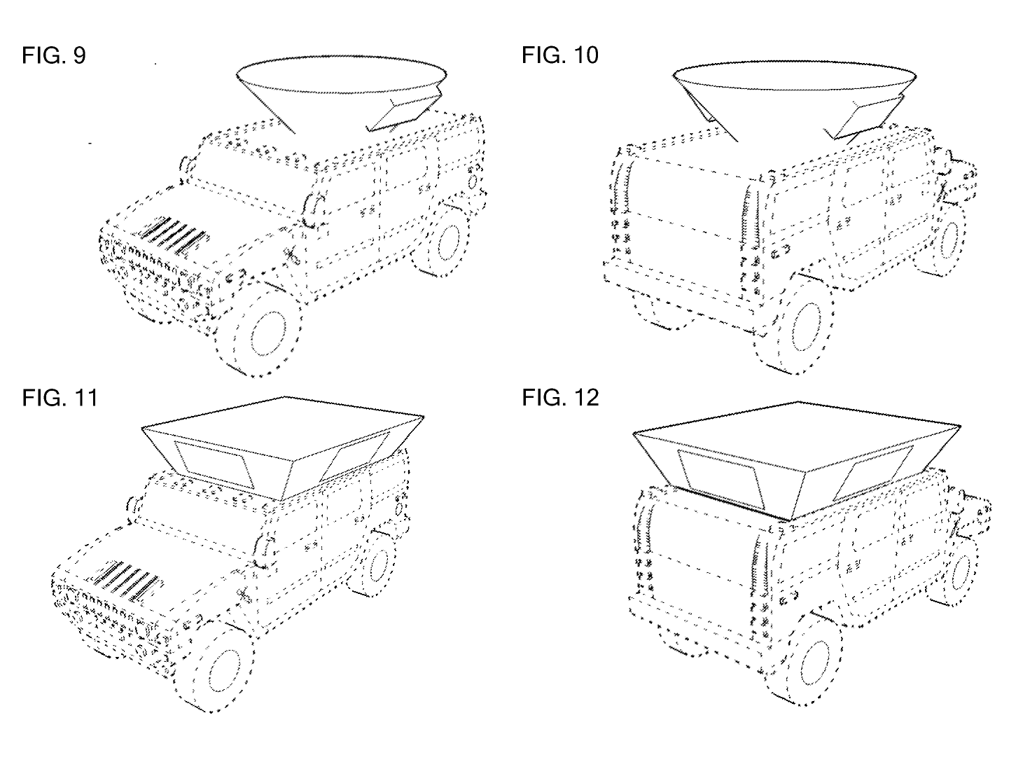

Further, a chamber may define, and/or multiple chambers may be connected and arranged on a vehicle roof to define, a variety of shapes of the media center. For example, as shown in FIGS. 1-4, 11, and 12, the viewing walls viewable from the sides of the vehicle comprise a rectangular shape, while the viewing walls viewable from before and behind the vehicle comprise a trapezoid shape having two parallel sides. The chambers are connected to define a trapezoid shape of the media center where the base walls of the chambers and a roof wall of the media center are parallel. Further, the media center may comprise rectangle-like shape (FIGS. 1 and 2), a wedge-like shape (FIGS. 3 and 4), an oval-like shape (FIGS. 5 and 6), a diamond-like shape (FIGS. 7 and 8), a circle-like shape (FIGS. 9 and 10), and a square-like shape (FIGS. 11 and 12). Media centers comprising a cube-like shape, a cylinder-like shape, a hexagon-like shape, and other polygon-like shapes are contemplated as well.

To reduce the weight of the media center and to minimize strain on a vehicle roof with the mounting of a media center thereon, the walls of the media center generally are configured at least partially, if not substantially, of a strong, yet relatively lightweight material. For example, in one embodiment, the walls of the chambers are configured substantially of lightweight aluminum. The walls may be interconnected via securing devices, such as, but not limited to bolts, nuts, screws, clamps, and interlocking pins and recesses. The interconnected walls generally are sealed with a substantially weather-proof sealant, such as, but not limited to a high viscosity urethane, to help secure the interconnected walls and to prevent dust and moisture from entering the chambers. Respective walls of multiple chambers may be connected and sealed with a weather-proof sealant. Further, as mentioned above, the media center may comprise a roof wall that may be provided over connected chambers to cover any gap or recession between the chambers and sealed with a weather-proof sealant to further secure and protect the chambers.

The viewing windows may be covered with a protective, relatively transparent material, such as, but not limited to an acrylic glass, such as Plexiglas®, to protect the monitors positioned behind the viewing windows. For example, in one embodiment, ½ inch Plexiglas® is installed in the viewing windows. The protective material provided to the viewing windows may comprise or be covered with a tinting material to further reduce glare and/or to otherwise further optimize viewing of the video monitors. The protective material may be secured to the viewing walls by any variety of securing devices. In addition, the protective material generally is sealed with a substantially weather-proof sealant to prevent particulate matter and/or moisture from seeping through the viewing window between the protective material and the viewing walls to which it is secured. The viewing windows generally comprise a shape and size substantially similar to the video display of the monitors. It is contemplated, however, that the viewing windows may comprise any desirable size, whether larger or smaller than the video monitors, and/or any shape, whether the same as or different than that of the video monitors.

The media center may further comprise one or more video players, such as, but not limited to, digital media players, digital video disc (DVD) players, and video cassette (VCR) players, electrically connected to one or more of the video monitors. The video players may be positioned within a vehicle with cables traveling through a hole in the vehicle roof to connect the players inside the vehicle and the monitors over the roof of the vehicle. Thereby, the monitors may display whatever video files are stored in and/or transmitted by the video players. In addition, the media center may comprise an audio system comprising one or more speakers connected to the video players and/or the monitors. Thereby, audio integrated into or coincident with the videos displayed by the monitors may be volubly projected from the media centers as well. The speakers may be positioned inside of the vehicle and/or, if weather-proof, secured to the exterior of the vehicle and/or secured to the chambers of the media center. The video player may comprise a computer comprising a digital media player and/or a DVD player and connectable to the audio system. The computer also may be connectable to the Internet, wirelessly or via a line connection if available, so that video, audio, and/or other digital files (e.g., photographs, documents, and/or presentations) stored on the computer and/or derived from the Internet may be presented over the media center. It is also contemplated that the video player may comprise a digital camera that may record, store, and/or play or display videos and/or still photographs. Thereby, video (and audio) files and photographs may be presented over the media center. Further, it is contemplated that the video player may comprise a video game system electrically connected to one or more of the video monitors, and the audio system if desired. Thereby, video games may be viewed and played over the media center. The cables connecting the video players and the video monitors comprise any cables operable to enable any or all of the above described, or otherwise inferable there-from, capabilities of the media center, such as any audio cables, video cables, and power cables.

To provide sufficient electric power support for the media center, the media center may comprise one or more batteries electrically coupled to the electrically powered components of the media center and/or may comprise one or more power cables for electrical connection to a power source connected to a grid. In one embodiment, a media center mounted on a vehicle comprises three supplemental vehicle batteries and is also electrically connected to the vehicle's battery under the hood of the vehicle. With this embodiment, a second alternator is provided to the vehicle to fully support the batteries and the media center. Thus, in this embodiment, the media center is powered by two charging circuits each generally comprising two vehicle batteries, one alternator, a power converter, one circuit breaker, and the necessary power cables. The three supplemental batteries are stored in the trunk area of the vehicle along with the video players.

The vehicle on which an embodiment of the media center may be mounted may be any vehicle comprising a roof strength sufficient to support the media center. Thus, the type of vehicle on which the media center is mounted generally is not of significant importance so long as the vehicle can sufficiently support the media center both when the vehicle is parked and moving. For exemplary purposes, a Hummer® is illustrated, in phantom, in FIGS. 1-12.

It is contemplated that the media centers described herein could be made much smaller than that which is illustrated in FIGS. 1-12 (e.g., 3-sided units) and could, for example, be mounted to smaller vehicles, like taxi cabs, etc. In any case, it is important to note that the electrical power used to drive the media center would be generated in the vehicle and that the media center may comprise a unit that is typically intended for interior use—in which case the aforementioned housing elements for the media center could be fabricated from sheet metal, Lexan®, safety glass, etc., and would be configured to provide protection from heat, cold, and other environmental and atmospheric conditions. Commercially available inverters are available for efficient operation, e.g., running at 25% of capacity with no duty cycle.

It is also noted that the various media centers described herein are typically provided in a housing that include an interior that is placed in direct communication with the interior or climate control system of the vehicle with which it is used. For example, in the case of a roof mounted media center, a cut-out or passageway can be provided in the vehicle roof to permit free flow of cool or warm air between the interior of the vehicle and the interior of the media center housing, thus creating the same climate controlled atmosphere inside the roof-top media center as is provided in the interior of the vehicle.

For the purposes of describing and defining the present invention it is noted that the terms “relatively” and “substantially” are utilized herein to represent the inherent degree of uncertainty that may be attributed to any quantitative comparison, value, measurement, or other representation. The terms “relatively” and “substantially” are also utilized herein to represent the degree by which a quantitative representation may vary from a stated reference without resulting in a change in the basic function of the subject matter at issue. It is further noted that terms like “generally,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

Having described the invention in detail and by reference to specific embodiments thereof, it will be apparent that modifications and variations are possible without departing from the scope of the invention defined in the appended claims. More specifically, although some aspects of the present invention may be identified herein as preferred or particularly advantageous, it is contemplated that the present invention is not necessarily limited to these preferred aspects of the invention.

What is claimed is:

1. A media center including one or more of the novel features described in the present application.

2. A vehicle comprising a roof mounted media center including one or more of the novel features described in the present application.

3. A method of providing a media center on a roof of a vehicle including one or more of the novel feature described in the present application.
